(19) United States
(12) Patent Application Publication
(10) Pub. No.: US 2017/0266879 A1
(43) Pub. Date: Sep. 21, 2017

(54) Method And Apparatus Of Very Much Faster 3D Printer

(71) Applicant: ASHOK CHAND MATHUR, PUNE (IN)

(72) Inventor: ASHOK CHAND MATHUR, PUNE (IN)

(21) Appl. No.: 15/482,767

(22) Filed: Apr. 9, 2017

Related U.S. Application Data
(63) Continuation of application No. PCT/IB2015/059801, filed on Dec. 19, 2015.

(30) Foreign Application Priority Data
Jun. 12, 2015 (IN) 2271/MUM/2015

(51) Int. Cl. B29C 67/00; G06T 7/50; B22F 3/105; G06T 19/20

(52) U.S. Cl. CPC B29C 67/0077; G06T 19/20; G06T 7/50; B29C 67/0088; B22F 3/1055; G06T 2219/2004; B33Y 50/02

(57) ABSTRACT

A 3D printer that is mostly twenty to thirty times faster than existing 3D printers. Pixel-based Raster images are converted into Scalable Vector Graphic (SVG) images, which are then categorized as lines, curves and surface areas. For each category, faster printing methods for printing with pre-formed shapes such as rods, boards, arcs, etc., are disclosed. Pre-formed shapes may be made of plastic/thermoplastic/polymer or sintering materials, as desired. Sintering materials may be cladded/coated with appropriate materials such as solder, copper, and thermoplastics. The new print-head, which has a fixed portion and a replaceable portion, has a mechanism to draw upon pre-formed shapes to print. The replaceable portion has varying shapes and sizes of placement holes, and a mechanism to signal which replaceable portion has been mounted. The print-head incorporates mechanisms to heat and tack the pre-formed shapes. The invention discloses methods to use multiple print-heads to further speed up printing.

### BACKGROUND

Field of Invention

The present invention relates to the apparatus and method of a newly invented 3D printer that prints the object at a speed of twenty to twenty five times as compared to the speed of existing 3D printers.

Discussion of the Prior Art

Already known printing methodologies are:

Typewriters Fixed Output, traded off with speed. The IBM Selectric-brand typewriter increased the speed by reducing the length of travel of the printing head, which was shaped like a ball. By changing the ball, the printable letters could be changed.

Dot Matrix printers Flexibility in output gained at the expense of speed. Only a single pixel could be printed at a time.

Inkjet printers Impact (noise) traded off with complex print-heads, and possibility of color added.

Laser printers Print-head stationary, drum rotates. The making of image is separated from fusing of image to paper.

Current 3D printers use the ink jet printers' paradigm with complex, slow print-heads.

This diverse range of printing devices essentially uses only two paradigms. The typewriter attempts to cover many pixels at once but only of limited shapes. All other printers follow the Raster Graphics paradigm to get flexibility of shape.

US 2014/018806 titled “Methods and apparatus for three-dimensional printed composites” discusses methods and apparatus for fabricating a 3D object. The invention describes the use of a wide variety of materials for the powder, substrate, and solvent or degrading agent. The invention produces composite materials, and thus can print 3D objects with highly desirable material properties, such as high strength and low weight. It describes how to fabricate objects at a very rapid pace, and can produce much larger objects than present technology. This invention has not discussed the process of enhancing the printing speed by using pre-formed shapes such as rods, boards, or arcs.

U.S. Pat. No. 8,847,953 titled “Apparatus and method for head mounted display indicating process of 3D printing” discusses a method for controlling a head mount display, which comprises the steps of detecting a 3D printer as a first marker through a camera unit; displaying a first augmented reality image of a shape of a 3D object on the basis of the detected first marker before the 3D object is output by the 3D printer; detecting the 3D object, which is output from the 3D printer, as a second marker if the 3D printer starts to output the 3D object; updating the first augmented reality image to a second augmented reality image on the basis of the first marker and the second marker; and, displaying the second augmented reality image. This invention has not discussed the step of converting Raster images into Scalable Vector Graphic (SVG) images.

U.S. Pat. No. 8,817,332 titled “Single-action three-dimensional model printing methods” discuss methods and techniques of using 3D printers to create physical models from image data. The invention describes geometric representations of different physical models and complex data conversion processes that convert input image data into geometric representations compatible with third party 3D printers.

### SUMMARY OF THE INVENTION

The primary object of the present invention is to provide a much faster 3D printer using new and novel paradigms that are drawn partly from Scalable Vector Graphics (SVG), partly from Calculus and Making of Geodesic Domes, and partly from Embroidery and other fields such as Welding.

The newly invented 3D printer will print most objects at twenty to twenty five times the speed of existing 3D printers. Those objects whose cross sections consist of straight lines, relatively shallow curves, and large smoothly enclosed cross sectional areas can be printed at nearly thirty times the speed of existing 3D printers. Further, those objects that consist largely of curves of thin cross sectional areas with tight tolerances can be printed at eight to ten times the speed of existing 3D printers.

Printing is done by pre-formed shapes such as rods, boards and arcs, which cover many pixels at one time. Scalable Vector Graphics are used to analyze the cross sectional areas into lines, curves and surface areas. Straight lines are printed directly by rods. Curves are printed by chords that approximate them such that the printed object is within the tolerance specified for it. Surface areas are printed using the long stitch paradigm from embroidery

The wastes of time and motion that are present in the normal 3D printer have been eliminated, and the needed printing time has been vastly reduced. By using pre-formed shapes (such as rods, boards, arcs), the times needed for heating of thermoplastic, extrusion of thermoplastic blobs, capping the extrusion hole and periodic cleaning of the extrusion hole are greatly minimized. By using a new paradigm of tack followed by weld, the time spent inside the print cycle in fusing the thermoplastic material is reduced to a far shorter time of heating for tacking only. By using two or more print-heads simultaneously, instead of only one print-head, the time to print new components is also reduced.

### BRIEF DESCRIPTION OF THE DRAWINGS

FIG. 1 shows a perspective drawing of a few rods.

FIG. 2 shows a perspective drawing of a few boards.

FIG. 3 shows a perspective drawing of a few arcs.

FIG. 4 shows a perspective drawing of the print area and its border.

FIG. 5 shows categories of vector images.

FIG. 6 shows the alignment of rods before and after the stability algorithm is run.

FIGS. 7(a), 7(b), 7(c) and 7(d) show an approximation of a curve by chords to that curve.

FIGS. 8(a), 8(b), 8(c) and 8(d) show some examples of intersections in the Curve Printing Optimization Algorithm.

FIGS. 9(a) and 9(b) show the flipping of second curve in the case of one intersection in the Curve Printing Optimization Algorithm.

FIGS. 10(a) and 10(b) show the case of two intersections in the Curve Printing Optimization Algorithm.

FIGS. 11(a), 11(b) and 11(c) show the various stages of processing that the Curve Printing Optimization Algorithm does in Stage 4 Step 7.

FIGS. 12(a) and 12(b), 12(c) show two alternate ways to use arcs to print curves.

FIGS. 13(a) and 13(b) show embroidery samples of both the Raster and Long Stitch paradigms.

FIGS. 14(a), 14(b) and 14(c) show diagrams of the working of the Stage 5 Step 1: Long Stitch Algorithm to cover Surface Areas.

FIGS. 15(a), 15(b) and 15(c) show three surface areas that have been drawn with their ‘long’ diagonal computed in Stage 5 Step 1.

FIG. 16 shows a block with an arbitrary pre-determined ‘long’ diagonal.

FIGS. 17 show the schematic of a print-head.

FIG. 18 shows the schematic of the preferred embodiment of the replaceable portion of the print-head.

FIG. 19 shows the perspective plan of the print-head.

FIG. 20 illustrates an embodiment of the invention making use of two print-heads simultaneously.

### DETAILED DESCRIPTION OF THE ACCOMPANYING EMBODIMENTS

The improved, faster 3D printer of the present invention uses a new paradigm that uses pre-formed shapes such as rods, boards, and arcs to print an image.

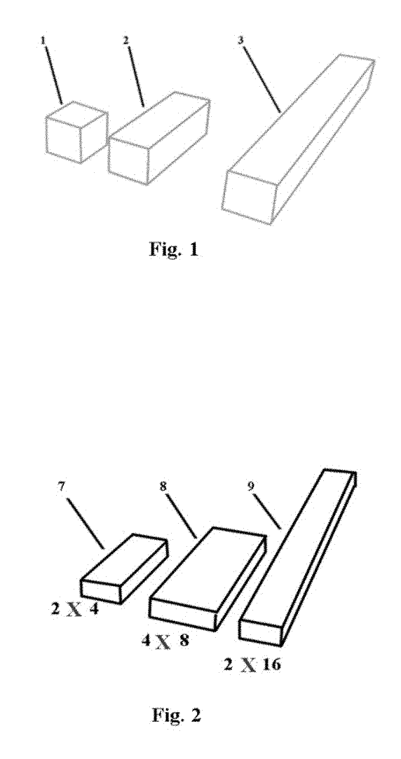

Rods: FIG. 1 shows a perspective drawing of some rods. A rod is a 3D pre-formed shape of material that will be used to print the 3D image. In one embodiment, a rod could be made of the plastic/polymer from which the image is to be printed. In another embodiment, a rod could be made of sintering material coated/cladded with plastic or other suitable materials described later. Rods can have various areas of cross-section that are convenient for the printing job at hand. At the minimum, a rod must be at least one pixel in cross-section. Rods can have different lengths. A rod can be of unit length 1, which is a cube 1 but is labeled as a rod for our purposes. A rod can be of two units' length, four units' length, fifteen units' length, and so on. Before the start of the printing process, the printer can choose to load limited types of rods, say five or six rods of different lengths from an inventory of say, without limitation, 25 to 30 different length rods. For understanding, assume that the printer has been loaded with five rods of unit lengths r1 to r5, with r1 being the shortest rod, and r5 being the longest rod. Assume that the lengths of the rods are as follows: r1=1 unit, r2=2 units, r3=4 units, r4=8 units and r5=15 units. The rods of unit length and two units' length are often useful; the other three rods can be of any convenient lengths.

Boards: There is another 3D pre-formed shape called “boards” that is used to print 3D images. FIG. 2 shows a perspective drawing of some boards. A board is a 3D pre-formed shape used for 3D printing, made up of materials such as plastic/polymer/sintering materials. In one embodiment, a board has a height of unit pixel. In other embodiments, a board's height can be varied according to the convenience of the user in the printing process. Its breadth may be 2, 3, 4, or more unit pixels. Its length can also vary, just as the lengths of rods vary. In the figure, examples for the board is given with breadth 2 and 4 pixel length 7, in second example four by eight 8, and in third example 2 by 16 9. In yet another embodiment, a board may have, for illustration, a height of one pixel, breadth of four pixels, and length of 32 pixels.

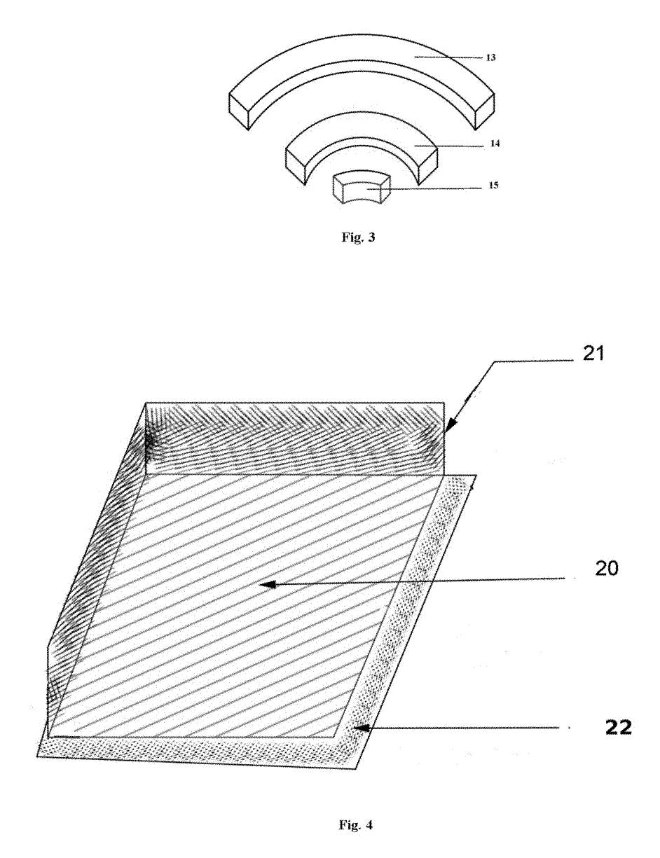

Arcs: Arcs are another 3D pre-formed shape that can be used to print 3D images. FIG. 3 shows a perspective drawing of some arcs. An arc is a 3D pre-formed shape used for 3D printing made up of materials such as plastic/polymer/sintering materials. In one embodiment, an arc has a height of unit pixel 13. Its radius may be 2, 3, 4, or more unit pixels. Its length can vary 14, 15 in the same way as lengths of rods vary.

Rods, Arcs and Boards combined: For printing certain objects, a printer may load only rods, or only arcs, or only boards. For other objects, a printer may load any combination of rods, boards, and arcs that optimizes the printing speed. In other words, the three pre-formed shapes arcs, rods, and boards can be used together in any combination that is suitable for the printing job.

Working of the Printer

FIG. 4 shows the print area and its border. Assume, without limitation, the following: (i) the printing area is a cube with each side being 10 cm 20, (ii) the printer will operate at 200 dpi, which corresponds to 80 dots per centimeter, and the radius of each pixel is =0.0625 mm, (iii) the object to be fabricated will be de-composed into 10*80=800 plane slices along the vertical axis 21, and (iv) if the print-head is a cube of 1 cm side each, then in the preferred embodiment, a margin 22 of 1 cm all around the print area allows the print-head to be parked there.

Pre-Printing Analysis

Stage 1: Existing and New: Vector Analysis

Stage 1 Step 1: Existing: Generate Plane Raster drawings

In the existing pre-printing process, the 3D drawing of the object is analyzed off-line into plane drawings. The present invention also follows the same step. In the above example, this process results into 800 Raster images, one for each plane, with each drawing being 10×10 cm in size.

Stage 1 Step 2: New: Convert Raster Images to SVG Images.

In the present process, the Raster images are converted into Scalable Vector Graphics (SVG) images, using Vector Graphics [1]. Each Raster image of 10×10 cm can be processed into a single SVG image. Alternatively, Step 2 can be implemented by subdividing the original Raster image into, say 1×1 cm blocks, or 100 blocks in all for the assumed print area. A different SVG image is derived for each such block. The rest of the description assumes that 100 such SVG images exist per plane. Now, discard Raster images, as they have no further use.

Stage 1 Step 3: New: Vector Image Analysis

In the preferred embodiment, this is a two-stage analysis, though in other embodiments, the number of stages could be more or less. In the first stage, parts of images are classified into three or more categories. In the second stage, for each category, a heuristically optimal method is computed to print the image with pre-formed shapes such as rods. The algorithm halts when any desired arbitrary closeness to the image is reached.

Stage 2: New: Categorization

Stage 2: Step 1: Categories

FIG. 5 shows three categories of vector images: relatively thin straight lines 27, relatively thin curves 28, and thick occupied surface areas between edges of two or more lines or curves 29. This categorization allows the use of heuristically optimal ways to print the image using pre-formed shapes, such as rods, of limited types. This categorization can be performed by mathematical calculations and rules, or by a trained neural network. If a neural network is used, the surface areas could be subdivided into many more sub-categories, which would speed up the printing process. The sub-categorizations are not described further here, though two surface area sub-categorizations, namely spiky objects and two-arm objects, are mentioned in subsequent description.

Stage 3: New: Line Printing Algorithm—Optimal printing methods for relatively thin straight lines

Relatively thin lines are printed using the Line Printing Algorithm (LPA) outlined below. Note that this algorithm is also invoked during the printing of curves and surfaces areas.

Stage 3 Step 1: LPA inputs

This algorithm expects to receive L, the length of the line to be sub-divided for optimal printing. The lengths of rods r5 to r1 are constants that are read from a store of value.

Stage 3 Step 2 LPA: Compute how many rods of length r5 can be used

Divide the length of the line L by r5 to calculate how many integer r5 rods can be used to print the line. If L is smaller than r5, the answer will be zero, and no r5 rod can be used to print that line. Otherwise, use integer r5 rods, and divide the remaining length by r4, as given below.

Stage 3 Step 3 LPA: Compute how many rods of length r4 can be used

Divide the length of the line/remaining length L by r4 to calculate how many integer r4 rods can be used to print the line. If L is smaller than r4, the answer will be zero, and no r4 rod can 20 be used to print that line. Otherwise, use integer r4 rods, and divide the remaining length by r3, as given below.

Stage 3 Step 4 LPA: Compute how many rods of length r3 can be used

Divide the length of the line/remaining length L by r3 to calculate how many integer r3 rods can be used to print the line. If L is smaller than r3, the answer will be zero, and no r3 rod can be used to print that line. Otherwise, use integer r3 rods, and divide the remaining length by r2, as given below.

Stage 3 Step 5 LPA: Compute how many rods of length r2 can be used

Divide the length of the line/remaining length L by r2 to calculate how many integer r2 rods can be used to print the line. If L is smaller than r2, the answer will be zero, and no r2 rod can be used to print that line. Otherwise, use integer r2 rods, and divide the remaining length by r1, as given below.

Stage 3 Step 6 LPA: Compute how many rods of length r1 can be used

The remaining (or original) length can always be printed by r1 rods that are of unit length.

Stage 3 Step 7 LPA: Stability analysis

Once the straight lines have been analyzed into component lengths, in the preferred embodiment, stability considerations have to be applied before printing. The reason is that grouping all long lengths at one end of the line with all short lengths 34 at the other end increases the probability that the structure will break down at the short end.

Stability Algorithm

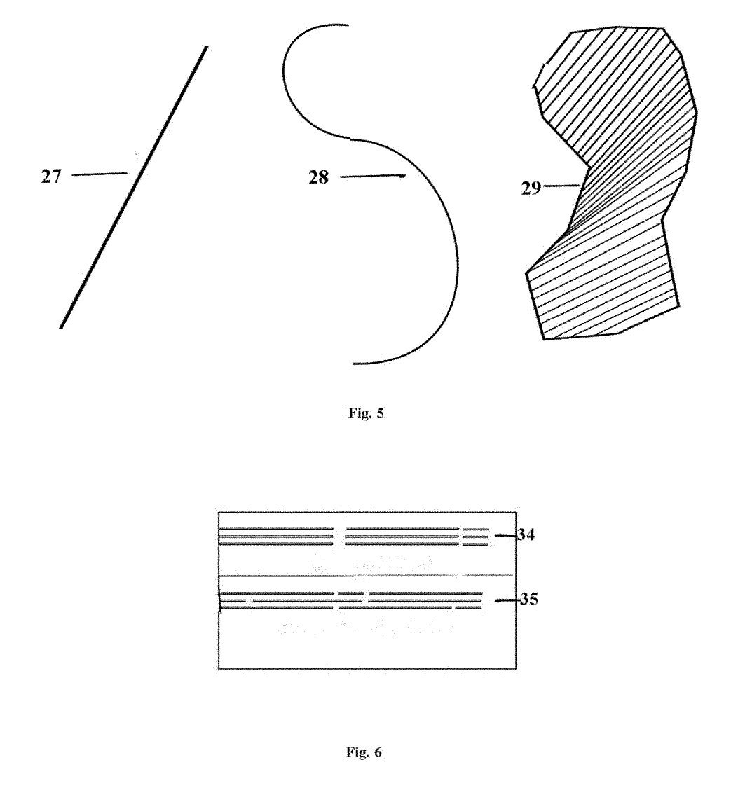

Civil construction experience suggests that the lengths need to be distributed in such a way that each discontinuity is against a solid portion on both its sides 35. A short sub-routine can easily re-arrange the distribution of rods between parallel lines. FIG. 6 shows what the subroutine will achieve.

Stage 4: Curve Printing: Optimal Printing Methods for Relatively Thin Curves

A relatively thin curve is printed by chords to that curve that are within the specified tolerance limit.

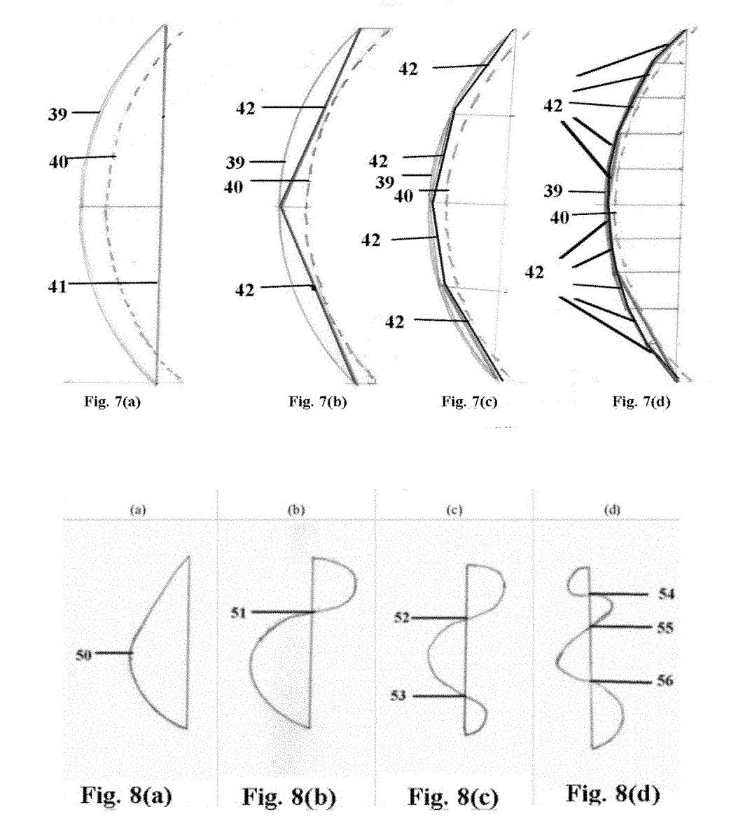

FIGS. 7(a), 7(b), 7(c) and 7(d) show an approximation of a curve by chord(s) to that curve.

FIG. 7(a) illustrates the original curve 39, the displaced tolerance curve 40, and a chord 41 that joins the extreme points of the original curve. FIG. 7(b) illustrates two chords 42 within the tolerance curve. FIG. 7(c) illustrates four chords 42 within the tolerance curve. FIG. 7(d) illustrates ten chords 42 within the tolerance curve.

Stage 4 Calculus [2], suppose f is a real-valued function, and c is a real number. The expression

$${lim}_{x \to c} f ( x ) = L$$

States that f(x) can be made to be as close to L as desired by making x sufficiently close to c. In that case, the above equation can be read as “the limit of f of x, as x approaches c, is L”. In other words, any continuous curve can be approximated by its chords. As the chord length tends towards zero, the chords come ever closer to the curve. A dot matrix printer, or an existing 3D printer, prints the curve with pixels. In a preferred embodiment, the chords to the curve are printed with pre-formed shapes such as rods. In another embodiment, the image will be printed with boards. In yet another embodiment, where the image requires tight tolerances, the curve is printed with arcs. In yet another embodiment, in the same image, some curves are printed by chords, other curves by arcs, and yet other curves by boards.

The construction of geodesic domes is a practical example of approximating arcs of spheres by their chords. In the common geodesic dome, the initial equilateral triangular faces of the icosahedrons are sub-dived into parts (frequencies), and the divided parts are made into chords with ends on the spheres. A 3-frequency subdivision yields good approximation for a small dome; for large domes, 6-frequency or 7-frequency sub-division suffices. A few very large domes use 32-frequency subdivisions. However, there is no mathematical reason why the sub-division frequency could not be 256 or 1024, or even higher. In the same way, the number of chords that approximate a curve can be as large as required.

There is a simple rule available, as a part of stage 4, to decide when an approximation of a curve by its chords is good enough. The rule uses the well-known industrial concept of tolerances to reach the halting point. “Dimensions, properties, or conditions may vary within certain practical limits without significantly affecting functioning of equipment or a process. Tolerances are specified to allow reasonable leeway for imperfections and inherent variability without compromising performance.” [3]

The rule states that chords to that curve that fit it well have to reside within the tolerance curve.

In the preferred embodiment, the optimization routines of stage 4 are implemented as a set of heuristics. The optimizing algorithm of stage 4 increases the printing speed by maximizing the use of longer length rods such that the resultant chords to the curve reside within the tolerance limit.

FIGS. 8(a), 8(b), 8(c) and 8(d) show the optimization solution, which is presented as series of steps in a Curve Printing Optimization Algorithm (CPOA). FIG. 8(a) illustrates a curve with no intersection 50. FIG. 8(b) illustrates a curve with one intersection 51. FIG. 8(c) illustrates curve with two intersections 52, 53. FIG. 8(d) illustrates a curve with three intersections 54, 55, 56.

Stage 4 Step 1: Curve Printing Optimization Algorithm: Tolerance

Let T be the tolerance allowed.

Stage 4 Step 2: Curve Printing Optimization Algorithm: Parallel Curve 5 Compute a curve identical to the original curve but displaced at distance T away from the original curve. Any number less than the tolerance value can be used, if desired.

Stage 4 Step 3: Curve Printing Optimization Algorithm: Straight Line

Compute the straight line 53 joining the extreme two end points of the curve 50.

Stage 4 Step 4: Curve Printing Optimization Algorithm: Compute Length

Compute the length L of the straight line between the extreme points of the curve.

Stage 4 Step 5: Curve Printing Optimization Algorithm: Number of Intersections

Check at how many points the straight line cuts the curve.

Stage 4 Step 6: Curve Printing Optimization Algorithm: Case process Case of Zero Intersection

The straight line is the single chord of the entire curve. The conversion of the single chord into multiple chords that approximate the curve better and print faster will be done as at Stage 4 Step 7 below.

Case of One Intersection

FIGS. 9(a) and 9(b) show the case of one intersection. FIG. 9(a) shows the original curve 61, the tolerance curve 60, and the chord AB joining the two extreme points of the original curve. At the point of intersection, the original curve 61 is broken into two separate curves AC and BC, with two separate chords. For one curve AC, the parallel identical curve 60 will continue to be relevant. This is the portion of the parallel curve that is on the same side as the chord. For the second curve CB, where the chord is opposite to the parallel curve, a new parallel curve 63 at a distance T has to be computed. FIG. 9(b) shows that for the arc BC the tolerance curve has been flipped 63 so that it comes to the left hand side of the arc, i.e., the same side where the chord BC is to the arc BC. Turn by turn, both the new curves and the new chords with respective parallel tolerance curves have to be sent to Stage 4: Step 7 below for conversion into multiple chords.

Case of Two Intersections

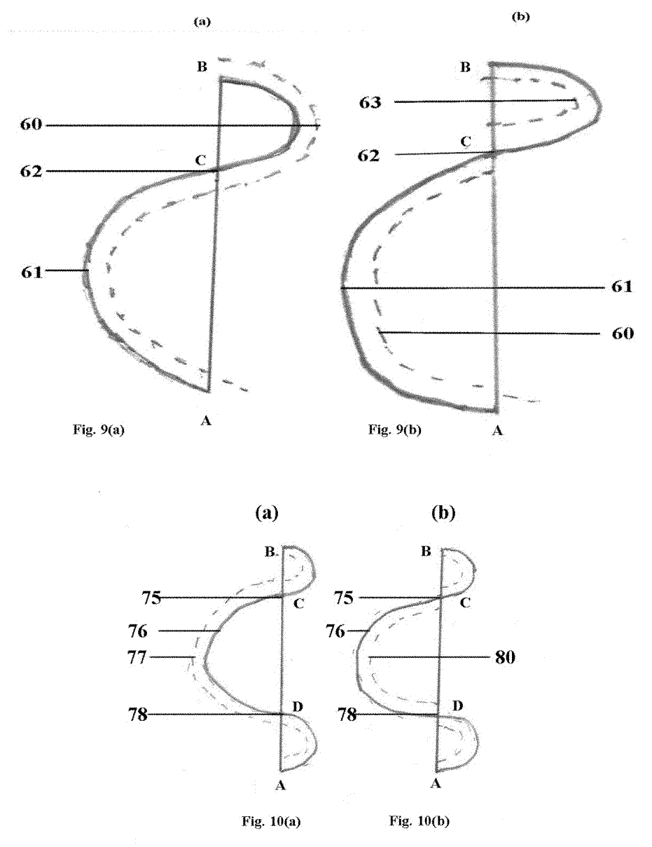

FIGS. 10(a) and 10(b) show the case of two intersections. At the points of intersections, the original curve is broken into three separate curves, with three separate chords. For two curves, 5 the parallel identical curve will continue to be relevant. This is the portion of the parallel curve that is on the same side as the chord. For the third curve, where the chord is opposite the parallel curve, a new identical but parallel curve at distance T has to be computed. FIG. 10(a) shows the curve AB 76 being trisected at C 75 and D 76 by the chord joining its end-points. The initial T displaced tolerance curve 77 is shown by dashed lines, and is to the left of the original curve. FIG. 10(b) shows that for the arc CD, the tolerance curve has been flipped 80, so that it comes to the right hand side of the arc, i.e., the same side where the chord CD is to the arc CD. The arcs AD and BC already have their tolerance curves on the same side as their chords. Therefore, they are left untouched. Turn by turn, the three new curves, and the new chords with respective parallel tolerance curves have to be sent to Stage 4: Step 7 below for conversion into multiple chords.

Case of n (three or more) Intersections

If there are n intersections, at the point of intersections, the original curve is broken into n+1 separate curves, with n+1 separate chords. If n is an odd number, for half the (n+1) curves the parallel identical curve will continue to be relevant. These are the portions of the parallel curve that is on the same side as the chord. For the other half of the (n+1) curves where the chord is opposite the parallel curve, a new identical but parallel curve at distance T has to be computed. Turn by turn, the (n+1) new curves and the new chords with respective parallel tolerance curves have to be sent to Stage 4: Step 7 for conversion into multiple chords.

If n is an even number, for (n/2+1) of the (n+1) curves, the parallel identical curve will continue to be relevant. These are the portions of the parallel curve that is on the same side as the chord. For the other (n/2) of the (n+1) curves, where the chord is opposite the parallel curve, a new identical but parallel curve at distance T has to be computed. Turn by turn, the (n+1) new curves, and the new chords with respective parallel tolerance curves have to be sent to Stage 4: Step 7 for conversion into multiple chords.

Stage 4 Step 7: Curve Printing Optimization Algorithm: New Chord Generation

Step 7 is invoked with these data parameters: (i) A path of a curve with its extreme points; (ii) A path of a parallel identical curve displaced at distance T, where the displacement is on the same side as the chord of the curve; and (iii) The length L of the straight line joining the two extreme points of the curve. (This can be computed within the algorithm itself from the coordinates of extreme points.)

Computations with Data

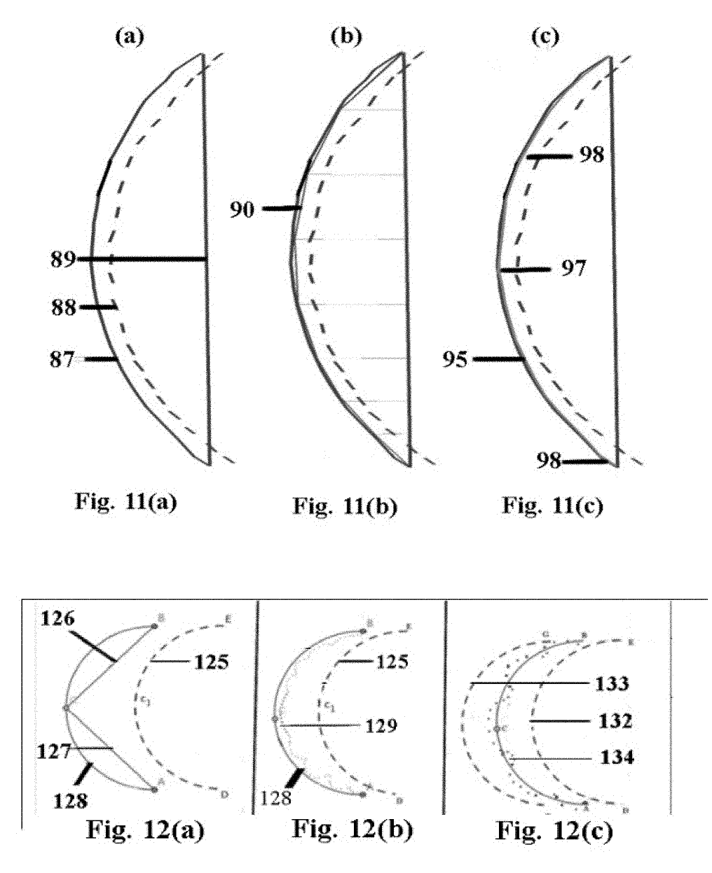

With this data, the algorithm computes new chords to the curve such that all the new chords lie between the original curve and the displaced parallel curve. The generated chords need not be of identical length; they can be of different lengths also. Once the new chords have been determined, each chord is resolved into rods of different lengths. FIGS. 11(a), 11(b) and 11(c) show the various stages of processing that Step 7 does. FIG. 11(a) shows the parameters passed to Step 7, i.e., the curve 87, the displaced curve 88 at distance T, and the chord 89 joining the two end-points. FIG. 11(b) shows the computed n chords 90 such that all the chords are within the displaced tolerance curve. FIG. 11(c) shows that most of the n chords have been replaced by blue colored r5 rods 95, while a few red chords representing r4 rods 98, and a few yellow colored rods 97 (may be r3 to r1, or a mix of them as needed) have been placed so as to give stability to the curve as a whole.

Stage 4 Step 7 Sub Step 7.1: Curve Printing Optimization Algorithm: Rapid convergence strategy

No Initial Stage Checking

The case that the existing chord of length L is entirely between the curve and the parallel curve is very rare and will occur for extremely shallow curves only. Hence, in the preferred embodiment, this is not checked for at the initial stage. Other embodiments may incorporate this check.

Rapid Convergence Strategy

It is possible to execute the subroutine in an incremental manner by replacing the existing chord by two chords, and then by three chords, until n chords exist that are all between the two parallel curves. The preferred embodiment jumps close to the final value of n by using a rapid convergence strategy, which is described below. Calculate the Rounded-up Value (next higher integer value) of dividing the length L of the existing chord by r5, the length of the longest rod. Let the result be an integer R.

Stage 4 Step 7 Sub Step 7.2: Curve Printing Optimization Algorithm: Rapid convergence strategy (continued)

In this step, the chord length L is divided into R equal pieces, and the y (vertical) axis coordinates of each piece (including the starting and ending points of the chord) are computed. These y-axis coordinates are used to calculate the points on the curve where lines drawn perpendicular to the chord would intersect the curve. Thus, R +1 pairs of (x, y), where x is the horizontal axis coordinate and y are the vertical axes coordinate are generated that are on the curve. R new chords are computed that join the adjacent pair of coordinates.

Stage 4 Step 7 Sub Step 7.3: Curve Printing Optimization Algorithm: Rapid convergence strategy (continued)

Check if any of the new chords intersect the parallel displaced curve. Even if one of them intersects, the sub-routine goes back to Sub Step 7.2 above with R replaced by R+1. If none of them intersect, the sub-routine passes on to Sub Step 7.4. When no chord intersects with the tolerance curve, it means that the chords are within the tolerance specified. If a still tighter fit is required, one more iteration with R replaced by R+1 can be run. A similar result can be achieved by reducing the tolerance value at the start of the routine.

Stage 4 Step 7 Sub Step 7.4: Curve Printing Optimization Algorithm: Rapid convergence strategy (continued)

Input

The algorithm receives the coordinates of R chords.

Computation

From this input data, the algorithm computes the lengths of R chords. As the chords are likely to be of different lengths, and their lengths are very unlikely to be integral multiples of r5, this step attempts to make most of the chords of an equal length that would be an integral value of r5. One chord would be of a different length, made up of r4 or lower value lengths.

Compute the average length of R chords, which is hereinafter called as Lavg. If Lavg is, say, for illustration purposes, within +/−20% of the value of an integral multiple of r5, convert all chords except one to that integral value of r5. The exceptional chord (whose length now will not be the same as before and differs by a few pixels and whose length will have to be recomputed from coordinates) can be composed in terms of r4 to r1 rods, as appropriate. With the new coordinates of the chords, go back to Stage 4 Step 7 Sub Step 7.3 to check if any of the chords intersect the parallel curve. If some of the chords do intersect the parallel curve, go back to Stage 4 Step 7 Sub Step 7.2 above with R replaced by R+1. If none of the chords intersects the parallel curve, then the set of chords that approximate the curve has been arrived at, and will be used for printing the curve.

Stage 4 Step 8: Curve Printing Optimization Algorithm: Repeat

Repeat the above procedure as many times as needed until a curve of required thickness is built-up.

Printing with Arcs

FIGS. 12(a), 12(b) and 12(c) show how arcs can be used in two alternate methods to print a curve. In the first method, shown in FIG. 12(a), the original curve BCA 128 has a tolerance curve Dc1E 125 drawn to one of its sides and two chords BC 126 and CA 127 have been drawn within the tolerance curves. In FIG. 12(b), the chords have been replaced by a series of arcs 129, just as chords are replaced by an appropriate mix of rods. FIG. 12(c) shows the alternate approach where two parallel tolerance curves 132 and 133 are drawn on both sides of the curve such that the two together are within the tolerance limit of the original curve, and various arcs 134 are also placed on both sides of the curve such that no arc crosses either of the tolerance curves.

Stage 5: Surface Area Printing: Optimal printing methods for Surface Area Printing

Printing of surface areas is not an extension of printing thin curves. A different paradigm is used to speed up printing surface areas. Embroidery often works on Raster-like thinking. For example, a cross-stitch in embroidery can be thought of as a large pixel. However, one embroidery technique uses a different paradigm that can be used to print faster using rods, boards, arcs, etc., instead of pixels.

A surface area: Definition

A surface area is contiguous and is enclosed by curves, where a line is a special case of a curve. A single circular or elliptical curve can enclose an area. However, in general, an area is enclosed by a number of irregular curves.

‘Long’ Diagonal: Definition

Formally, a diagonal is a line joining two nonconsecutive vertices of a polygon or a polyhedron. Surface areas are not always bound by polygons or polyhedrons; therefore, they may not have diagonals. Nevertheless, for our purposes, we define a ‘long’ diagonal of any surface area as the line with the longest such length joining a pair of non-adjacent points on the curve enclosing a surface.

If only the finite set of integral values of x and y coordinates that the surface area spans is used, then there is a large, but finite, set of lines that can join non-adjacent points on the surface. Call these lines as diagonals of the surface area. The diagonal with the longest length is defined as the ‘long’ diagonal.

It is understood that this ‘long’ diagonal is not the true long diagonal, which might have been discovered if we had truly generated the infinite set of lines that join all the non-adjacent points on the surface. The finite set of points used to calculate the ‘long’ diagonal can be further reduced by choosing x and y coordinates such that they have an integral value that is a multiple of 5, 7, or 10, etc. The value of the multiple is chosen so that the task of finding the ‘long’ diagonal does not become a drag on computation. The computation task can be further reduced by taking into account only those points that have a common x coordinate or a common y coordinate.

The Long Stitch Embroidery Paradigm

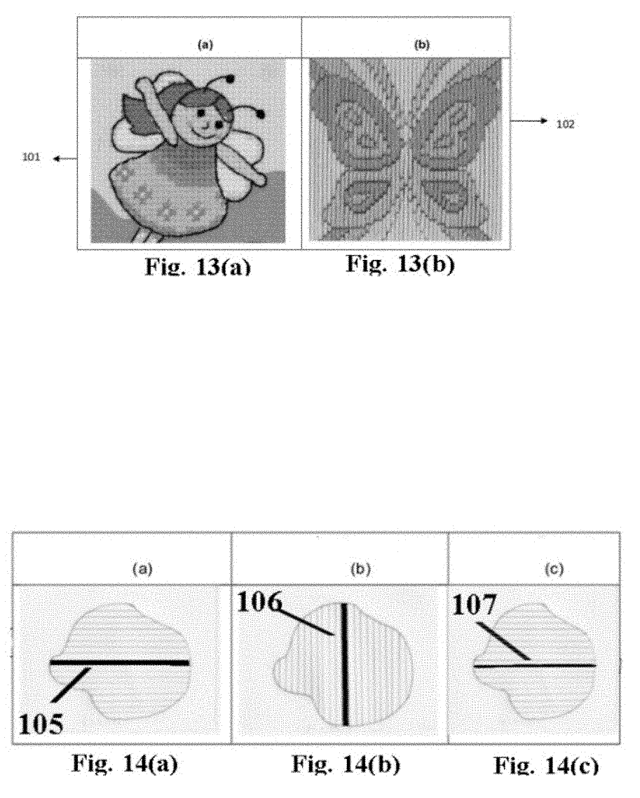

While most of embroidery follows a Raster image paradigm 101 to fill an area, there is at least one exception to this paradigm. This exception is the long stitch paradigm 102. FIGS. 13(a) and 13(b) shows an embroidery sampler of both the raster and long stitch paradigms. In FIG. 13(a), Raster like pixels has been used to embroider the picture. In FIG. 13(b), rod/board like long stitches has been used to cover large surface areas. The printing paradigm first defines a ‘long’ diagonal to any surface area, and then finds all intersections that lines drawn perpendicular to the ‘long’ diagonal make with the curves that define the area. Lengths of perpendicular lines, within the surface area, are printed with rods.

Stage 5 Step 1: Long Stitch Algorithm: Find the ‘long’ diagonal

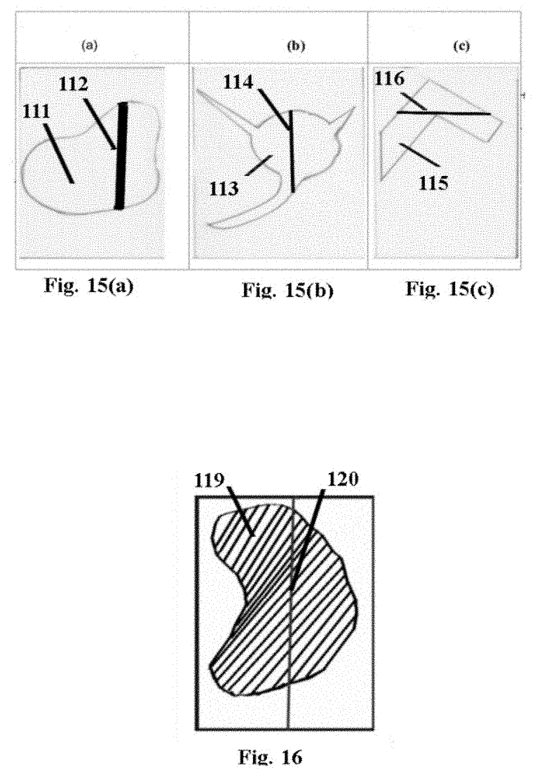

FIGS. 14(a), 14(b) and 14(c) show the diagram of the working of Stage 5 Step 1 to find the ‘long’ diagonal. FIG. 14(a) illustrates the discovery of the value of 1×105, defined below. FIG. 14(b) illustrates the discovery of the value of by 106, defined below. FIG. 14(c) illustrates the discovery of the long diagonal 107. Compute 1, the length of a surface area as the distance between its two extreme values of x co-ordinates of points on the surface. Compute b, the breadth of a surface area as the distance between its two extreme values of y co-ordinates of points on the surface. Using integral values that are a multiple of 5, 7, 10, or any other suitable number, compute where a straight line drawn at that integral value of x would intersect the curve. For some surface areas, the line may intersect the area more than once. Compute the distance between the points of first intersect to the point of last intersect. Label this as lx. From the various values of lx, find the maximum length of the intersect lx 105. In a similar manner, find the values of by, the lengths of intersects drawn parallel to y-axis 106. The higher of the two values lx and by is designated as the ‘long’ diagonal 107 of the surface.

Stage 5 Step 2: Long Stitch Algorithm: Find the extended ‘long’ diagonal

FIGS. 15(a), 15(b) and 15(c) show the Stage 5: Step 2 of the Long Stitch Algorithm for computing the extended ‘long’ diagonal. They show three surface areas that have been drawn with their ‘long’ diagonal computed in Stage 5: Step 1 above. In the case of a smoothly oblong area 111 as shown in FIG. 15(a), extending the computed ‘long’ diagonal by a few pixels in either direction makes it possible to compute the true length of the ‘long’ diagonal 112, which will make it possible to cover the entire surface area with rods laid perpendicular to the ‘long’ diagonal. In case of spiky objects 113 as shown in FIG. 15(b) with long spikes extending from a relatively oblong area, the incremental approach will be unnecessarily computationally heavy. The same might be true in the case of two-arm objects 115 as shown in FIG. 15(c).

Stage 5 Step 2 Sub Step 2.1:Long Stitch Algorithm: Binary search to find the True ‘long’ diagonal

A binary search will ease the burden of computation to find the start and end points of the ‘long’ diagonal. Extend the ‘long’ diagonal in both directions by its own length so that its length now becomes 31.

Stage 5 Step 2 Sub Step 2.2:Long Stitch Algorithm: Binary Search (continued)

At both of the new extreme points of the extended ‘long’ diagonal, draw lines perpendicular to the ‘long’ diagonal, and check at how many points they intercept the curves enclosing the surface areas.

Stage 5 Step 2 Sub Step 2.3: Long Stitch Algorithm: Case Process

These case values are to be tested at both ends of the extended ‘long’ diagonal.

Case of Zero Intercept

This case implies that the extended ‘long’ diagonal has overshot its true length at that end. Thus, at that end, the length of the ‘long’ diagonal (presently 31) is reduced by half of the original ‘long’ diagonal length, and Sub Step 2.2 is invoked again with the new length (1.51) at the end being checked.

Case of One Intercept

This case implies that the perpendicular is a tangent to the curve, and therefore the true diagonal length at that end has been discovered. This value is stored for later use.

Case of Two Intercepts

This case implies that the surface area extends beyond the already computed length. Thus, at that end, the length of the ‘long’ diagonal is again increased by the original ‘long’ diagonal length, and Sub Step 2.2 is invoked with the new length (21) away at the end being checked. Sub Step 2.3 ends when, with the newly discovered lengths, there is only one intercept at both the ends. As this discovery is a binary search process, it will end quite quickly.

In another embodiment, Sub Step 2.1 and Sub Step 2.2 of the algorithm are replaced by an arbitrary line drawn in the middle of the block so that rods automatically align with the direction of traverse of the print-head. FIG. 16 illustrates the alternate embodiment approach with an arbitrary long diagonal drawn 120 across the block 119.

Stage 5 Step 3: Long Stitch Algorithm: Traverse the ‘Long’ Diagonal

In a loop, traverse the ‘long’ diagonal from start to end in increments of a single pixel. At every pixel, compute at how many places does a line drawn perpendicular to the long diagonal intersect the surface area edges. In most of the cases, the points of intersection will occur in pairs. For each such pair, there is a need to compute the distance I between the points of intersections. When the line drawn is a tangent, there will be only a single intersection. In that case, I will be equal to 1. When the line drawn runs along the straight-line edge of the curve, then there will be as many intersections as the length of the edge. In that case, I will be equal to the length of the edge (the distance between the two extreme points of intersections).

Stage 5 Step 4: Long Stitch Algorithm: Decompose 1 into a Suitable Number of r5 to r1 Rods

This step is executed by invoking the Line Printing Algorithm, which has already been described in Stage 3. The stability considerations mentioned in that algorithm also apply to surface area printing. In the preferred embodiment, that routine needs to be applied to this printing also.

Stage 6: Store Print Positions

At the end of pre-printing analysis, for each plane that is to be printed, and, in the preferred embodiment, for each block within that plane, values of optimal placements of the pre-formed shapes such as rods, boards and arcs would have been computed and stored in memory for a computer to direct the print-head during printing.

Sintering Material

Using existing technologies related to metal sintering materials, it is possible to pre-form rods, boards, and arcs from sintering materials. In the preferred embodiment of the invention, once the pre-formed shapes have been created from sintering materials, their surfaces will be coated/cladded with solder, or a thin layer of copper, or thermoplastics. This coating/cladding is such that tack welding can take place with high power lasers that are placed on the print-heads for sintering materials.

Print-Head

The print-head has the following improvements/enhancements over known print-heads.

Print-Head: Replaceable Turret Type Print-Head

In the preferred embodiment, the print-head is designed similar to a turret in a Computer Numeric Control (CNC) machine. In a CNC machine, a turret holds a variety of tools for optimally manufacturing certain types of objects. When a different type of object is to be manufactured, the entire turret head is replaced. Similarly, in the 3D printer, the print-head has a fixed portion and a replaceable portion; the fixed portion receives and holds the replaceable portion. Different replaceable portions may have different holes and alignments for pre-formed shapes of different sizes. The use of pneumatics to transport and eject ink is a well-established technology in ink jet printers. This, or similar technology, can easily be used to transport pre-formed shapes and eject them from the openings when required. The design of transportation tubes has to be such that the sharp corners of rods/boards do not block the tube. Rounded rectangular tubes can provide a solution.

In the preferred embodiment, the main supply source of pre-formed shapes is not mounted on the replaceable part of the print-head. The main supply of pre-formed shapes will be outside the print area, from where pneumatic tubes will supply them to the fixed portion of the print-head. The portion of the print-head above the replaceable portion holds a limited supply, say up to ten at a time, of pre-formed shapes of each type. The replaceable print-head has a second set of pneumatic rounded rectangular tubes that feed a short holding space directly above the pre-formed shape placement openings. The replaceable print-head has a pneumatic system of expelling a single pre-formed shape from its opening, as and when required.

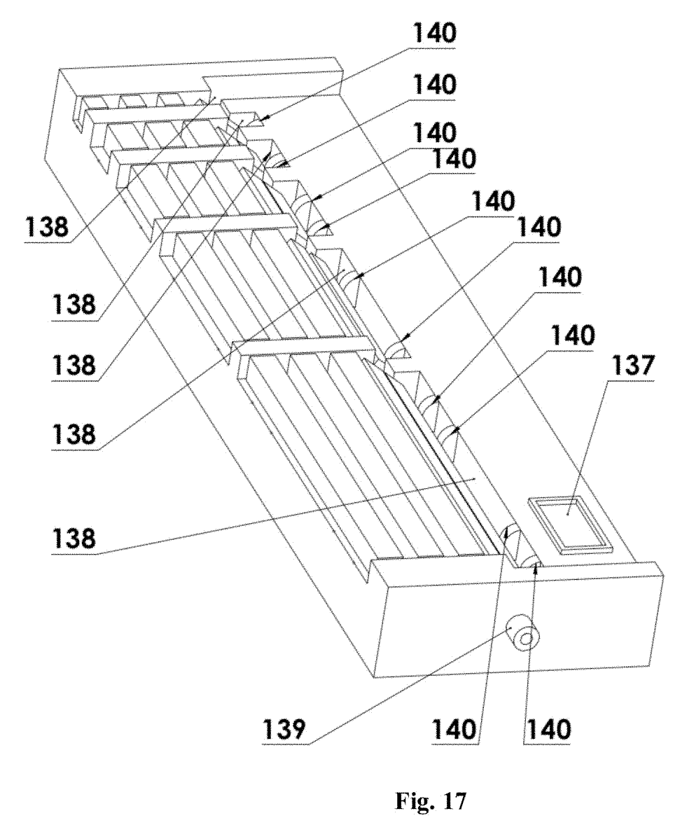

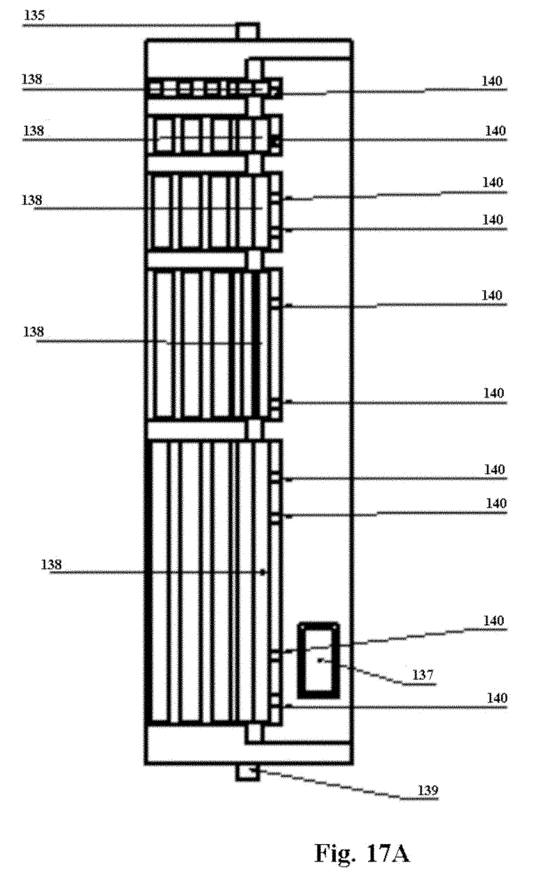

FIG. 17 shows the schematic of the preferred embodiment of the replaceable portion of the print-head. The schematic shows that all the placement holes 138 from where the pre-formed shapes will fall down are aligned in a straight line in the center of the print-head. The pre-formed shapes are prevented from prematurely falling down by a bi-metallic strip mechanism 140. The holes have physical separators between them. Pre-formed shapes that are awaiting their turn to fall down 144 are stacked on the one side (left hand side in one embodiment), where they will be replenished from time to time. The pneumatic mechanism to replenish them is not shown. The schematic diagram shows two laser guns 135, 139 mounted at each end of the print-head. The guns are capable of a swilling motion so that they can heat pre-formed shapes below them, including those placed at an angle to the line of traverse.

With a replaceable portion, the printer has to check if the correct replaceable portion has been fixed. In the preferred embodiment, an electronic hand-shaking device (chip) 137 is built in the replaceable portion to identify which replaceable portion is in place.

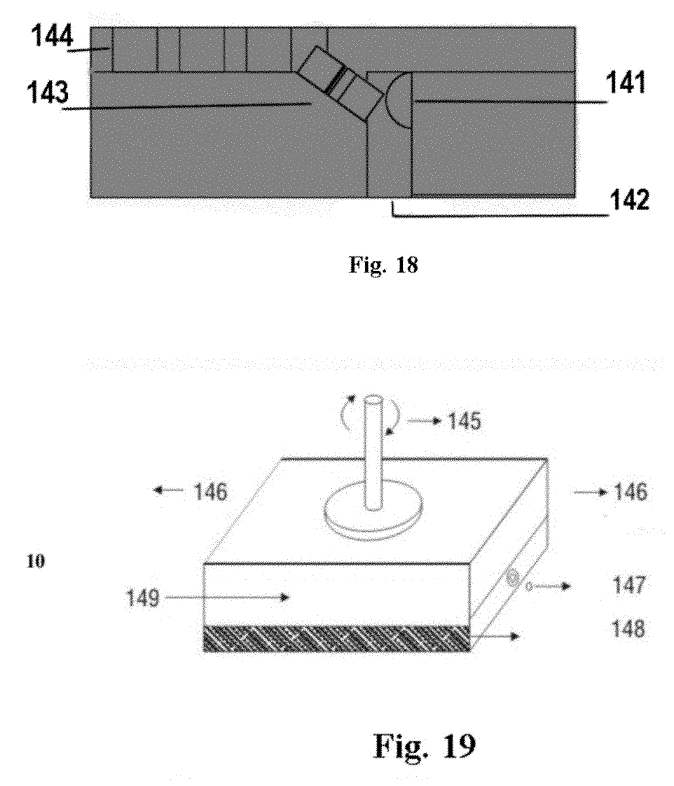

In FIG. 18, a method where the print-head has a system of using a bi-metallic strip(s) 141 to prevent a pre-formed shape from prematurely falling down the placement hole 142. Other embodiments could use other mechanisms to prevent the pre-formed shapes from falling down prematurely.

Assume that, without limitations, we are using rods of lengths r1=1 unit, r2=2 units, r3=4 units, r4=8 units, and r5=15 units to print. Then, the preferred embodiment of the print-head will look like a long rod, slightly longer than the sum of rods r1 to r5. Given the assumed dimensions of r1 to r5, the sum of the lengths of the five rods is 15+8+4+2+1=30 pixels. Some spacing is needed between the holes for pushing out the rods. Assume, without limitations, that such spacing is five pixels wide. Including the spacing at the start and end of the holes, the required six spaces will add another 5*6=30 pixels of length. Hence, the minimum total length will be 30+30=60 pixels.

In another example, assume that the lengths are r5=32, r4=15, r3=8, r2=2, and r1=1. Given the assumed dimensions of r1 to r5, the sum of lengths of the five rods is 32+15+8+2+1=58 pixels. Spacing will need another 30 pixels as before. Hence, the minimum total length of the print-head, including supporting spaces that are five pixels wide, will be 58+30=88 pixels.

In another embodiment, the rods can be placed in two parallel rows on the print-head. One row would have only the single longest rod r5 of length 32 pixels in it. With support spacing, its total length would be 32+5+5=42 pixels. The parallel row would have the remaining four rods of 1, 2, 8, and 15 lengths, and with five spaces of five pixels each, the length of this row would be 5+1+5+2+5+8+5+15+5=51 pixels. The print-head's length would have to be the length of the longer of the two parallel rows i.e., 51 pixels length. This two-row print-head is structurally stronger than a longer single-row print-head, which can easily bend out of shape.

Cross-Section of the Replaceable Portion of Print-Head

FIG. 18 shows a schematic cross-section of the replaceable portion of the print-head. In the preferred embodiment, the cross-section shows how bi-metallic strips 141 prevent a pre-formed shape from falling down until the print-head reaches the desired portion. The cross-section also shows the inclined plane 143, down which pre-formed shapes will slide until they reach the placement hole 142. It may be necessary to supplement the force of gravity for the sliding movement with a pneumatic push mechanism; this mechanism has not been shown.

In the replaceable two-row print-head embodiment, at any time, only one of the two rows is directly in line with the path that the printer is taking. If the pre-formed shape to be used is located in the other non-aligned row, then, on reaching its position, the print-head has to make a sidewards (wiggle) motion to bring the second row in line. The number of times this sidewards movement takes place will be mitigated by proper placement of pre-formed shapes (including duplicate placement of certain pre-formed shapes) in the two rows.

The schematic in FIG. 19 illustrates the fixed portion 149 and the replaceable portion 148 of the print-head. The figure shows the swill axis 145, the direction of traverse 146, and the laser guns 147 mounted. As with the existing pixel-based printers, the new 3D printer needs motors and software to impart slow and high speed traverse motion to the print-head. Pre-formed shapes have direction, and can be placed at an angle to the direction of traverse. This angle may also be perpendicular to the direction of traverse. Existing software has to be modified so that it can include the angle of the pre-formed shape to the direction of traverse. For a pre-formed shape to be placed at an angle to the direction of traverse, the print-head swills, as a whole, on its axis until it reaches the required angle, and then releases the pre-formed shape.

In the preferred embodiment, swill capabilities are powered by an additional motor. To print curves in vertical spaces, rods need to be placed so that there is an overhang, compared to the pre-formed shape(s) under them. Though an overhang of up to 50 percent of the dimension of the pre-formed shape results in the center of gravity of the new pre-formed shape being within the surface of the pre-formed shape below, it is customary to restrict the overhang to, say, 33 percent to 40 percent. Regardless of the chosen value of the permitted overhang, there is a requirement of a wiggle movement that displaces the print-head by a maximum of a half pixel. In the preferred embodiment, the newly introduced swill motor handles this task also.

Print-head: Tack and Weld Paradigm

In many existing 3D printers, the print-head imparts structural stability by melting the plastic/polymer, and then extruding it over an unsolidified pixel; the two pixels fuse together when they become cold. This may be called the Fuse paradigm. Instead of the Fuse paradigm, the printer of the present invention follows a Tack and Weld paradigm. The Tack and Weld paradigm allows the separation of the formation of the structure from the imparting of strength to the formed structure. Initially during printing, the pre-formed shapes are held in correct position by quick tacks. Subsequently, the imparting of strength by welding/fusing can be done, as desired, within the print area, or outside the print area.

In the new 3D printer, the upper surface of the existing pre-formed shape on which the new pre-formed shape is to be placed is heated by lasers guns, which are mounted on the two opposite sides of the printer. Simultaneously, the lower surface of the new pre-formed shape is also heated by the laser guns. The total heat delivered by the two laser guns is sufficient to allow parts of the two pre-formed shapes to join at some points; i.e., the pre-formed shapes are tacked together by this heat. The tack allows the two pre-formed shapes to stay in position. In the schematic in FIG. 17, one laser gun 135 on the replaceable portion of print-head is mounted in the front of the print-head, and points in the direction of movement of the print-head. It heats the next lower existing pre-formed shape, on which the new pre-formed shape will be placed. The second laser gun 139 is mounted at the back of the replaceable portion of print-head, and points backward in the direction that print-head has recently traversed. The laser beams are capable of swilling so that they can retain their focus on the pre-formed shapes that are to be heated. The second laser gun is used to heat pre-shaped forms that have already been placed on top of each other.

In another embodiment, the laser guns are placed at the front and back of the fixed portion of the print-head, where the print-head swills as a whole. In yet another embodiment, the laser guns are placed at both the fixed and the replaceable portions of the print-head, and used as a heat source for fusing.

Print-Head: Two or More Simultaneous Print-Heads

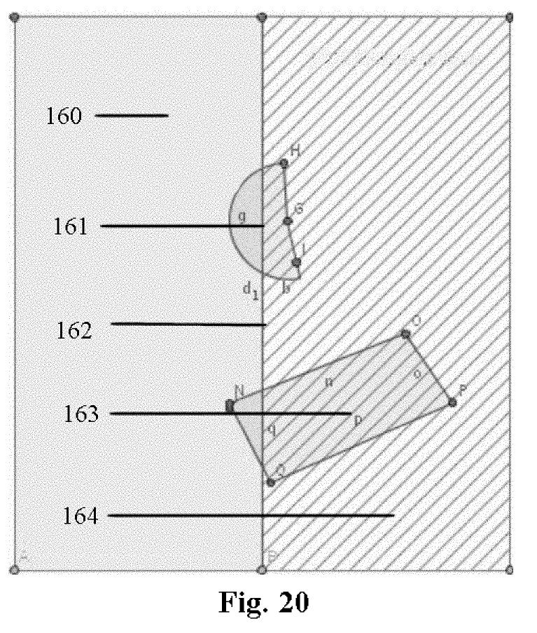

There is no restriction that there can be only one active print-head during the printing operation. A few simple conflict-resolving rules will allow the simultaneous operation of two or more print-heads, thus further improving the printing speed. FIG. 20 shows a print area divided into two halves 160, 164 by the center line 162. Two print-heads would print these halves simultaneously.

In the preferred embodiment, one print-head prints the center line, and all pixels to the right of the center line. This print-head is called the Main print-head. The second print-head prints all pixels to the left of the center line. This print-head is called the Left print-head. When a pre-formed shape straddles the center line such as the arc 161 or a board 163, or is on it in any way, the Main print-head will print it. In FIG. 20, because the arc 161 and the board 163 straddle the center line, both would be printed by the Main print-head.

In another embodiment, where four print-heads operate simultaneously, the print area is first divided into two equal halves (Right and Left), and then each half is divided into two more halves (Upper and Lower Rights, and Upper and Lower Lefts). In this embodiment, the simple rule will be modified so that both Upper and Lower Right print-heads can print anything that is on or straddles the center line of the complete print area. Within the Right area, anything on its center line or that straddles the center line will be printed by the Upper Right print-head and the rest will be done by the Lower Right print-head. A similar rule will apply between the Upper and Lower Left print-heads.

In yet another embodiment, it may be advantageous to use two print-heads that move in spirals. The Main print-head would be the one that moves from the center of the print area towards the periphery until it crosses the circle at the half-way radius. The Left print-head would move from the periphery towards the center until it crosses the half-way radius. As in the other embodiments, all pre-formed shapes that lie on the half-way circle, or touch it or straddle it, would be printed by the Main print-head.

The examples illustrated and the different embodiments mentioned in the specification are only for clear understanding of the invention, and therefore, do not limit the invention.

### REFERENCES

1. http://en.wikipedia.org/wikiNector_graphics)

2. http://en.wikipedia.org/wiki/limit₁₃ %28mathematics %29

3. http://en.wikipedia.org/wiki/Engineering_tolerance

1. A 3D printing process to enhance the speed of printing by known process, the improvement includes performing a pre-printing analysis, comprising the steps of:
a. Converting pixel based raster images into Scalable Vector Graphic (SVG) images;
b. Categorization of SVG images into two, three or more categories;
c. For each category, optimizing printing methods for printing with pre-formed shapes such as rods, boards, arcs, etc., instead of printing with pixels;
d. Computing optimal placements of the pre-formed shapes and storing the placements in the memory of a computer;
e. Communicating the memory of the computer to a print-head configured to handle the pre-formed shapes; and
f. Employing one or more print-heads simultaneously.

2. The 3D printing process of claim 1, where the categories of SVG images include:
a. Relatively thin straight lines 27;
b. Relatively thin curves 28; and
c. Thick occupied surface areas 29.

3. The 3D printing process of claim 1, where the analysis further comprises the steps of:
a. Analyzing a 3D drawing of an object to be printed into multiple plane raster drawings 101;
b. Converting plane raster drawings 101 into the SVG images, where:
i. Withdrawn Raster image can be converted into SVG image or;
ii. Withdrawn Raster image can be sub-divided into multiple blocks, and different SVG image be made from each such block; and
c. Analyzing the SVG images, which is a two-stage analysis, where:
i. In the first stage, parts of images are categorized into two, three or more categories; and
ii. In the second stage, for each category, a heuristically optimal method is computed to locate the placement points for the pre-formed shapes, including rods 1, 2, 3, boards 7, 8, 9 and arcs 13, 14, 15 to print the image.

4. The 3D printing process of claim 1, where optimizing printing methods for various categories include optimal printing methods for relatively thin straight lines 27, further comprising the steps of:
a. Receiving expected inputs such as the length of the line to be sub-divided for optimal printing;
b. Analyzing the straight lines into component lengths;
c. Computing the number of rods of different lengths that can be fitted by dividing the length of the line by the length of rods to be fit, and dividing the remaining length by the length of shorter rods recursively; and
d. Optionally distributing the lengths so that stability of the object 35 to be printed is ensured using the stability algorithm.

5. The 3D printing process of claim 1, where optimizing printing methods for various categories include optimizing printing methods for the relatively thin curves 28, further comprising the steps of:
a. Calculating the tolerance limit ‘T’ of the Withdrawn curve 39;
b. Computing a parallel curve 40 displaced at a distance of the tolerance limit ‘T’ to the Withdrawn curve 39;
c. Computing the straight line by joining the two extreme points of the curve 41;
d. Calculating the length of the straight line that joins the two extreme points of the curve 41; and
e. Checking the number of intersections of the straight line with the Withdrawn curve in different cases, such as the case of zero intersection 50, one intersection 51, and two or more intersections 52, 53, 54, 55, 56.

6. The 3D printing process of claim 1, where optimizing printing methods for various categories include optimizing printing methods for the relatively thin curves 28, further comprising the steps of:
a. Dividing the curve at each point of intersection into two separate curves with two separate chords;
b. Computing tolerance limit ‘T’ for the new identical but parallel curves, and then sending for conversion into multiple chords;
c. Using a rapid convergence strategy, generating multiple chords such that all these new chords lie between the Withdrawn curve 61 and the displaced parallel curve 60, 63; then
d. Dividing the length of the chord ‘L’ by the length of the rod;
e. Calculating the points on the curve where the lines drawn perpendicular to the chords would intersect the curve 62, using y-axis coordinates;
f. Computing R new chords with generated R+1 pairs of (x, y) coordinates, and the joined adjacent pair of coordinates;
g. Computing the average length of chords with different lengths from the input coordinates of R chords;
h. Dividing the average length by the length of the longest rod. If there is any remaining length then it is again analyzed using the previous steps;
i. Generating new chords such that all the chords lie in between the two parallel curves;
j. Resolving each new chord into rods of different lengths;
k. Optionally imparting stability to the placement of the rods; and
l. Repeating the process until a curve of required thickness is built-up.

7. The 3D printing process of claim 1, where optimizing printing methods for various categories include optimal printing methods for the surface areas 29, further comprising the steps of:
a. Using a long stitch embroidery paradigm 102, where a long diagonal 107 of the surface area is found, and the length of the long diagonal 107 is calculated;
b. Calculating the length of the surface area, ‘lx’ 105, which is the distance between the two extreme points on x-axis and breadth of the surface area, and the length ‘by’ 106, which is the distance between the two extreme points on y-axis; and then comparing them to find out the long diagonal of the surface area 107;
c. Using an alternate approach to compute the long diagonal by drawing an arbitrary line 120 in the middle of the surface area 119 that aligns itself in the direction of traverse of print-head, and then computing the length ‘I’ of the long diagonal by traversing it from start to end;
d. Extending the long diagonal in both directions by its length; at both the new extreme points of the ‘extended’ diagonal, drawing lines perpendicular to the long diagonal 107;
e. Testing the number of intercepts in different cases using a binary search process;
f. Counting the number of places the long diagonal intersects with the edges of the surface area, and drawing a line that passes through the points of intersection, where:
i. If the line drawn is a tangent, then length ‘I’ equals to 1, or if the line drawn runs along the straight edge of the curve, ‘I’ equals to the length of the edge; and
ii. The calculated length ‘I’ is decomposed into number of rods of different lengths.

8. The 3D printing process of claim 1, where optimizing printing methods for various categories include optimal printing with boards in a manner similar to rods.

9. The 3D printing process of claim 1, where optimizing printing methods for various categories include optimal printing with arcs, further comprising the steps of:
a. Computing the displaced tolerance curve 125 and the chords that lie within the tolerance limit of the curve 128, and then generating multiple new chords;
b. Dividing the length of the new chords created by the length of the arcs;
c. Calculating the number of arcs 129 of different lengths to be fitted, in a way similar to that for optimizing printing methods for curves; and
d. Generating the multiple new chords by computing two parallel curves 132, 133 on either side of the Withdrawn curve, with the two curves together being within the tolerance limit of the Withdrawn curve 128 such that all arcs 134 are within the tolerance curves and may straddle the Withdrawn curve.

10. The 3D printing process of claim 1, where optimizing printing methods for various categories include optimal printing with any combination of rods, boards, arcs and other desired pre-formed shapes.

11. The 3D printing process of claim 1, where a material capable of being sintered is used to pre-form shapes such as rods, boards, arcs, etc. such that:
a. The pre-formed shapes may consist only of sintering material;
b. The pre-formed shapes may be coated with low temperature melting materials such as solder, thermoplastics, or copper; and
c. The print head includes high power laser guns to melt the cladding/sintering material, as required.

12.
12.1 A 3D printer having one or more print heads that utilizes pre-formed shapes to print.
12.2 A 3D printer of claim 12.1 where the print heads may have only a fixed portion or may have a fixed potion and a replaceable portion or any combination thereof.
12.3 A 3D printer of claim 12.2 where the print head has a fixed portion 149, a replaceable portion 148, a release/hold mechanism such as bi-metallic strips 141, and laser guns 135, 139, and is configured to handle pre-formed shapes, such that:
a. The print-head has a fixed portion 149 that receives and holds the replaceable portion 148, where different replaceable portions may have different holes 138 for the pre-formed shapes of different sizes and shapes;
b. The main supply of pre-formed shapes will be outside the print area, from where pneumatic tubes will supply them to the print head;
c. A portion of the print-head holds a limited supply of pre-formed shapes. The replaceable print head has a second set of the pneumatic rounded rectangular tubes that feed a short holding space directly above the pre-formed shape placement holes;
d. The print head uses a bi-metallic strip 141 to prevent pre-formed shapes from prematurely falling down the placement hole 142;
e. The holes 138 have physical separators between them; the pre-formed shapes that are awaiting their turn 144 to fall are stacked on one or both sides, and the pneumatic mechanism helps to replenish them;
f. The print-head has laser guns 135, 139 mounted at each end of it, and is capable of swill and wiggle motions; and
g. The print-head has an electronic hand-shaking device (chip) 137 built in the replaceable layer 148 to check if the replaceable portion that has been mounted has the desired hole openings.

13. The print-head for 3D printing of claim 12, where the laser guns may be positioned in different ways:
a. The guns 135, 139 placed at the front and back of the fixed portion 149 of the print-head; and
b. The gun 147, which is placed at both the fixed 149, and the replaceable portions 148 of the print head are used as a heat source for fusing.

14. The print-head for 3D printing of claim 12, where motors allow the print head to:
a. Swill by the required angle to place the pre-formed shapes at an angle to the direction of traverse 146; and
b. Wiggle the print-head by a required distance to allow an overhanging placement of newly placed pre-formed shapes over older already placed pre-formed shapes.

15. The 3D printing process of claim 12, where two or more print-heads can be employed simultaneously, where:
a. Printing a center line 162 and right side of the center line 164, with one print-head called the main print-head. The other print-head prints all the left side of the center line 161; and
b. The printing process, which utilizes spiral movements, has two print-heads such that each print-head prints nearly an equal area one half-way radius from the center of the circle and half-way from the outer edge, and the main print-head prints the central spiral and all those inside it.

16. The 3D printer of claim 12, where the pre-formed shapes deposited on the print bed are held in position by using a Tack and Weld paradigm, comprising:
a. Allowing the separation of the formation of the structure from imparting strength to the formed structure;
b. Holding the pre-formed shapes in the correct position with quick tacks by placing and heating of the new pre-formed shape on the upper surface of the existing pre-formed shapes;
c. Simultaneously, the lower surface of the new pre-formed shape is also heated by the laser guns 135, 139; and
d. Imparting the strength, as desired, within the print area or outside the print area.
